(19) United States
(12) Patent Application Publication
(10) Pub. No.: US 2008/0245247 A1
(43) Pub. Date: Oct. 9, 2008

(54) Printing machine

(75) Inventors: Motoharu Yamauchi, Kyoto (JP); Keisuke Hirai, Kyoto (JP); Hideharu Okuda, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 12/078,974

(22) Filed: Apr. 9, 2008

(30) Foreign Application Priority Data
Apr. 9, 2007 (JP) 2007-101310

(51) Int. Cl. B41F 5/16

(52) U.S. Cl. 101/174

(57) ABSTRACT

A printing machine includes a decurler 51 for correcting curling of printing paper by sucking the printing paper with images printed thereon, a powder mechanism 61 for applying an anti-offset powder to the printing paper with the images printed thereon, a blower 71, a first pipeline 74 connecting the decurler 51 and an intake port 72 of the blower 71, a second pipeline 76 connecting the powder mechanism 61 and an exhaust port 73 of the blower 71, and a powder tank 62 storing the anti-offset powder.

### BACKGROUND OF THE INVENTION

1. Field of the Invention

This invention relates to a printing machine for printing multicolor images on printing paper by using plate cylinders each having a plurality of image areas formed peripherally thereof.

2. Description of the Related Art

Printing machines for printing multicolor images on printing paper by using plate cylinders are described in Japanese Patent No. 3466867 and Japanese Patent No. 3600727, for example.

Not only such a printing machine but an ordinary printing machine uses a decurler in order to correct curling of printing paper occurring at a printing time (see Japanese Unexamined Patent Publication No. 2000-255870). This decurler corrects curling of printing paper by using a blower to suck the printing paper having images printed thereon.

In the ordinary printing machine, a powder mechanism is used in order to prevent offset on the printing paper after printing. This powder mechanism uses a blower to apply an anti-offset powder to the printing paper after printing.

Where a printing machine is equipped with the decurler and powder mechanism noted above, a plurality of blowers are installed in the printing machine. This results in not only an enlarged construction but also an increased cost of the printing machine.

### SUMMARY OF THE INVENTION

The object of this invention, therefore, is to provide a printing machine which is compact in construction and can reduce manufacturing cost, even when equipped with a decurler and a powder mechanism.

The above object is fulfilled, according to this invention, by a printing machine for printing images in multiple colors on printing paper by using a plate cylinder having a plurality of image areas formed peripherally thereof, the printing machine having a transport path for transporting the printing paper with the images printed thereon in a transport direction, the printing machine comprising a decurler disposed on the transport path for correcting curling of the printing paper by sucking the printing paper with the images printed thereon; a powder mechanism disposed on the transport path and spaced from the decurler by a distance at least corresponding to a length of the printing paper in the transport direction, for applying an anti-offset powder to the printing paper with the images printed thereon; a blower having an intake port for drawing in air, and an exhaust port for exhausting the air drawn in through the intake port; a first pipeline connecting the decurler and the intake port of the blower; and a second pipeline connecting the powder mechanism and the exhaust port of the blower.

This printing machine, even with the decurler and powder mechanism, is compact in construction and can reduce manufacturing cost.

In one preferred embodiment, the printing machine allows the sucking force of the decurler to be adjusted without affecting the powder mechanism.

In another preferred embodiment, the printing machine allows an amount of powder applied by the powder mechanism to be adjusted without affecting the decurler.

Other features and advantages of the invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a schematic view of a printing machine according to this invention;

FIG. 2 is a schematic view showing a construction of a decurler, a powder mechanism and associated components;

FIG. 3 is an explanatory view showing curl correcting operation of the decurler;

FIG. 4A is an explanatory view of curl correcting operation of the decurler, and powder applying operation of the powder mechanism;

FIG. 4B is an explanatory view of curl correcting operation of the decurler, and powder applying operation of the powder mechanism;

FIG. 5 is an explanatory view illustrating a modified printing machine; and

FIG. 6 is an explanatory view illustrating another modified printing machine.

### DESCRIPTION OF THE PREFERRED EMBODIMENTS

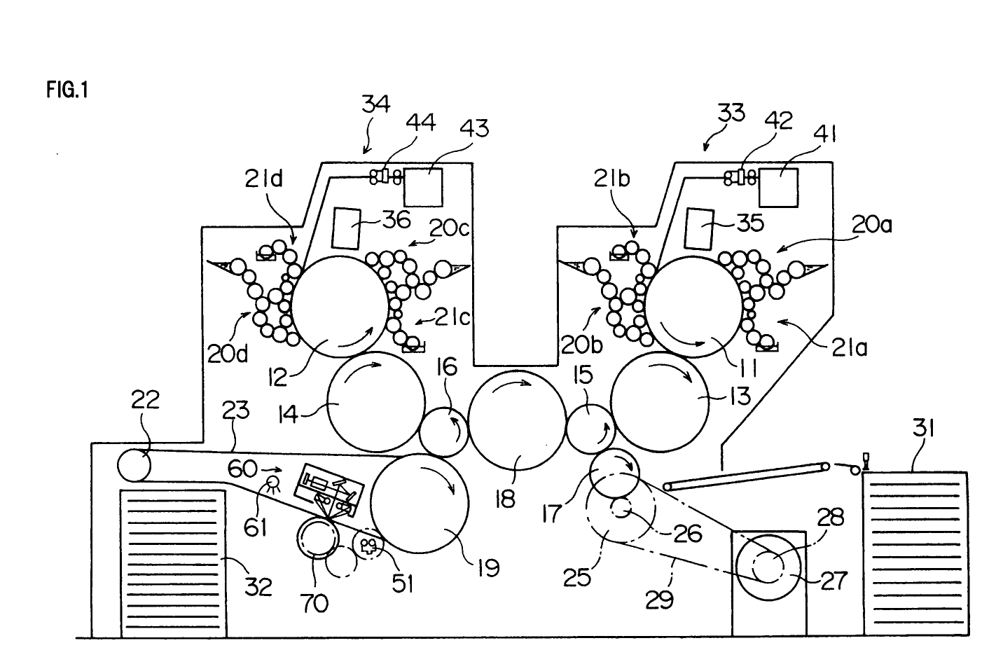

Embodiments of this invention will be described hereinafter with reference to the drawings. FIG. 1 is a schematic view of a printing machine in a first embodiment of the invention.

This printing machine records images on blank plates mounted on first and second plate cylinders 11 and 12 in a prepress process, feeds inks to the plates having the images recorded thereon, and transfers the inks from the plates through first and second blanket cylinders 13 and 14 to printing paper held on first and second impression cylinders 15 and 16, thereby printing the images in four colors on the printing paper.

The printing machine has the first plate cylinder 11, the second plate cylinder 12, the first blanket cylinder 13 contactable with the first plate cylinder 11, the second blanket cylinder 14 contactable with the second plate cylinder 12, the first impression cylinder 15 contactable with the first blanket cylinder 13, and the second impression cylinder 16 contactable with the second blanket cylinder 14. The printing machine further includes a paper feed cylinder 17 for transferring printing paper supplied from a paper storage station 31 to the first impression cylinder 15, a transfer cylinder 18 for transferring the printing paper from the first impression cylinder 15 to the second impression cylinder 16, a paper discharge cylinder 19 with chains 23 wound thereon and extending to and wound on sprockets 22 for discharging printed paper from the second impression cylinder 16 to a paper discharge station 32, and an imaging unit 60 for reading the images printed on the printing paper.

Each of the first and second plate cylinders 11 and 12 is what is called a two-segmented cylinder for holding two printing plates peripherally thereof for printing in two different colors. The first and second blanket cylinders 13 and 14 have the same diameter as the first and second plate cylinders 11 and 12, and each has blanket surfaces for transferring images in two colors.

The first and second impression cylinders 15 and 16 movable into contact with the first and second blanket cylinders 13 and 14, respectively, have half the diameter of the first and second plate cylinders 11 and 12 and the first and second blanket cylinders 13 and 14. The first and second impression cylinders 15 and 16 have grippers, not shown, for holding and transporting the forward end of printing paper.

The paper feed cylinder 17 disposed adjacent the first impression cylinder 15 has the same diameter as the first and second impression cylinders 15 and 16. The paper feed cylinder 17 has a gripper, not shown, for holding and transporting, with every two rotations of the feed cylinder 17, the forward end of each sheet of printing paper fed from the paper storage station 31. When the printing paper is transferred from the feed cylinder 17 to the first impression cylinder 15, the gripper of the first impression cylinder 15 holds the forward end of the printing paper which has been held by the gripper of the feed cylinder 17.

The transfer cylinder 18 disposed between the first impression cylinder 15 and second impression cylinder 16 has the same diameter as the first and second plate cylinders 11 and 12 and the first and second blanket cylinders 13 and 14. The transfer cylinder 18 has a gripper, not shown, for holding and transporting the forward end of the printing paper received from the first impression cylinder 15, and transferring the forward end of the printing paper to the gripper of the second impression cylinder 16.

The first and second impression cylinders 15 and 16 and the transfer cylinder 18 may be replaced with a single impression cylinder contactable with both the first and second blanket cylinders 13 and 14.

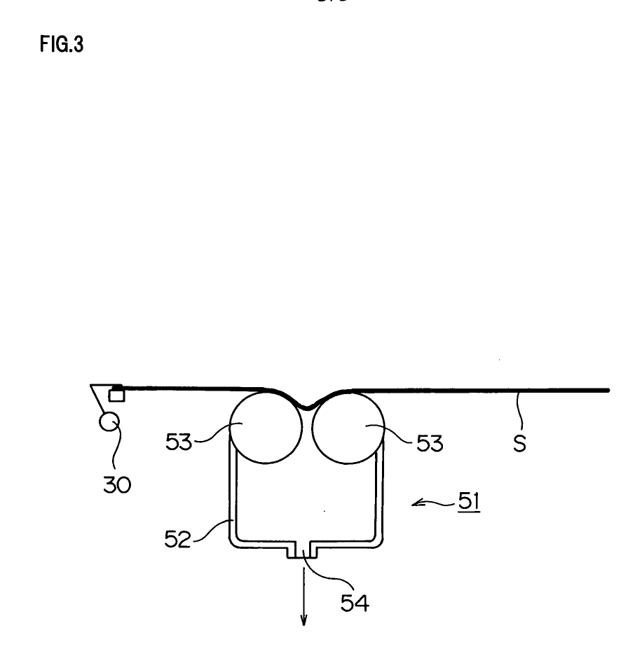

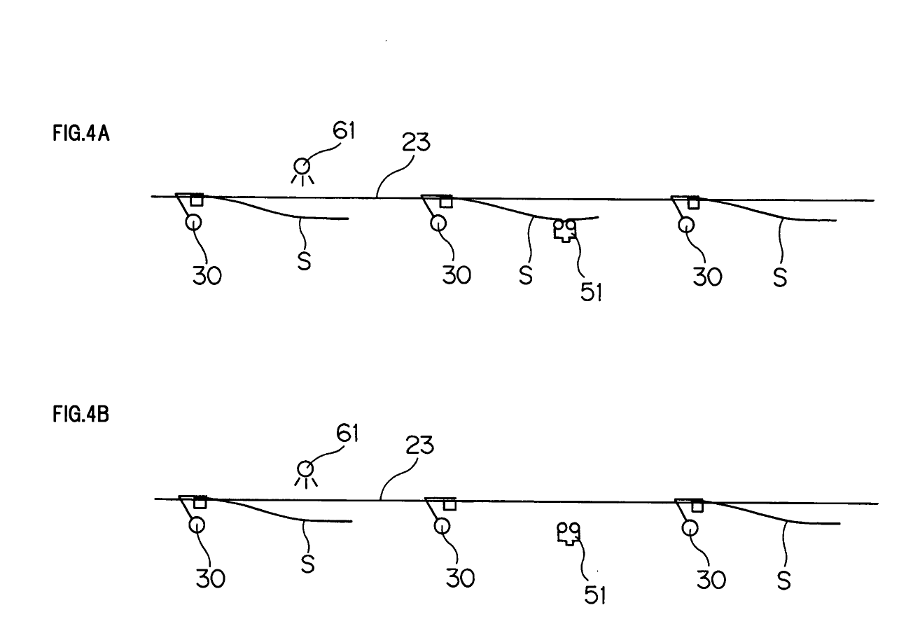

The paper discharge cylinder 19 disposed adjacent the second impression cylinder 16 has the same diameter as the first and second plate cylinders 11 and 12 and the first and second blanket cylinders 13 and 14. The discharge cylinder 19 has a pair of chains 23 wound around opposite ends thereof. The chains 23 are interconnected by coupling members, not shown, having a plurality of grippers 30 arranged thereon (FIGS. 3 and 4). When the second impression cylinder 16 transfers the printing paper to the discharge cylinder 19, one of the grippers 30 on the discharge cylinder 17 holds the forward end of the printing paper having been held by the gripper of the second impression cylinder 16. With movement of the chains 23, the printing paper is transported to the paper discharge station 32 to be discharged thereon.

When the printing paper is discharged, as described hereinafter, a decurler 51 corrects curling of the printing paper produced at the printing time, and a powder mechanism 61 applies powder to the printing paper for preventing an offset on the printing paper after printing.

The paper feed cylinder 17 has a gear attached to an end thereof and connected to a gear 26 disposed coaxially with a driven pulley 25. A belt 29 is wound around and extends between the driven pulley 25 and a drive pulley 28 rotatable by a motor 27. Thus, the paper feed cylinder 17 is rotatable by drive of the motor 27. The first and second plate cylinders 11 and 12, first and second blanket cylinders 13 and 14, first and second impression cylinders 15 and 16, paper feed cylinder 17, transfer cylinder 18 and paper discharge cylinder 19 are coupled to one another by gears attached to ends thereof, respectively. Thus, by the drive of motor 27, the paper feed cylinder 17, first and second impression cylinders 15 and 16, paper discharge cylinder 19, first and second blanket cylinders 13 and 14, first and second plate cylinders 11 and 12 and transfer cylinder 18 are rotatable synchronously with one another.

The first plate cylinder 11 is surrounded by an ink feeder 20a for feeding an ink of black (K), for example, to a plate, an ink feeder 20b for feeding an ink of cyan (C), for example, to a plate, and dampening water feeders 21a and 21b for feeding dampening water to the plates. The second plate cylinder 12 is surrounded by an ink feeder 20c for feeding an ink of magenta (M), for example, to a plate, an ink feeder 20d for feeding an ink of yellow (Y), for example, to a plate, and dampening water feeders 21c and 21d for feeding dampening water to the plates.

Further, arranged around the first and second plate cylinders 11 and 12 are a plate feeder 33 for feeding plates to the peripheral surface of the first plate cylinder 11, a plate feeder 34 for feeding plates to the peripheral surface of the second plate cylinder 12, an image recorder 35 for recording images on the plates mounted peripherally of the first plate cylinder 11, and an image recorder 36 for recording images on the plates mounted peripherally of the second plate cylinder 12.

In the printing machine having the above construction, a printing plate stock drawn from a supply cassette 41 of the plate feeder 33 is cut to a predetermined size by a cutter 42. The forward end of each plate in cut sheet form is guided by guide rollers and guide members, not shown, and is clamped by clamps of the first plate cylinder 11. Then, the first plate cylinder 11 is driven by a motor, not shown, to rotate at low speed, whereby the plate is wrapped around the peripheral surface of the first plate cylinder 11. The rear end of the plate is clamped by other clamps of the first plate cylinder 11. While, in this state, the first plate cylinder 11 is rotated at high speed, the image recorder 35 irradiates the surface of the plates mounted peripherally of the first plate cylinder 11 with a modulated laser beam for recording an image thereon.

Similarly, a printing plate stock drawn from a supply cassette 43 of the plate feeder 34 is cut to the predetermined size by a cutter 44. The forward end of each plate in cut sheet form is guided by guide rollers and guide members, not shown, and is clamped by clamps of the second plate cylinder 12. Then, the second plate cylinder 12 is driven by a motor, not shown, to rotate at low speed, whereby the plate is wrapped around the peripheral surface of the second plate cylinder 12. The rear end of the plate is clamped by other clamps of the second plate cylinder 12. While, in this state, the second plate cylinder 12 is rotated at high speed, the image recorder 36 irradiates the surface of the plates mounted peripherally of the second plate cylinder 12 with a modulated laser beam for recording an image thereon.

The first plate cylinder 11 has, mounted peripherally thereof, a plate for printing in black ink and a plate for printing in cyan ink. The two plates are arranged in evenly separated positions (i.e. in positions separated from each other by 180 degrees). The image recorder 35 records images on these plates. Similarly, the second plate cylinder 12 has, mounted peripherally thereof, a plate for printing in magenta ink and a plate for printing in yellow ink. The two plates also are arranged in evenly separated positions, and the image recorder 36 records images on these plates, to complete a prepress process.

The prepress process is followed by a printing process for printing the printing paper with the plates mounted on the first and second plate cylinders 11 and 12. This printing process is carried out as follows.

First, each dampening water feeder 21 and each ink feeder 20 are placed in contact with only a corresponding one of the plates mounted on the first and second plate cylinders 11 and 12. Consequently, dampening water and inks are fed to the plates from the corresponding water feeders 21 and ink feeders 20, respectively. These inks are transferred from the plates to the corresponding regions of the first and second blanket cylinders 13 and 14, respectively.

Then, the printing paper is fed to the paper feed cylinder 17. The printing paper is subsequently passed from the paper feed cylinder 17 to the first impression cylinder 15. The impression cylinder 15 having received the printing paper continues to rotate. Since the first impression cylinder 15 has half the diameter of the first plate cylinder 11 and the first blanket cylinder 13, the black ink is transferred to the printing paper wrapped around the first impression cylinder 15 in its first rotation, and the cyan ink in its second rotation.

After the first impression cylinder 15 makes two rotations, the printing paper is passed from the first impression cylinder 15 to the second impression cylinder 16 through the transfer cylinder 18. The second impression cylinder 16 having received the printing paper continues to rotate. Since the second impression cylinder 16 has half the diameter of the second plate cylinder 12 and the second blanket cylinder 14, the magenta ink is transferred to the printing paper wrapped around the second impression cylinder 16 in its first rotation, and the yellow ink in its second rotation.

The forward end of the printing paper printed in the four colors in this way is passed from the second impression cylinder 16 to the paper discharge cylinder 19. The printing paper is transported by the pair of chains 23 toward the paper discharge station 32 to be discharged thereon.

When the printing paper is discharged, as noted hereinbefore, the decurler 51 corrects curling of the printing paper produced at the printing time, and the powder mechanism 61 applies powder to the printing paper for preventing an offset on the printing paper after printing.

After the printing process, the printing paper printed is discharged. The first and second blanket cylinders 13 and 14 are cleaned by a blanket cylinder cleaning device, not shown, to complete the printing process.

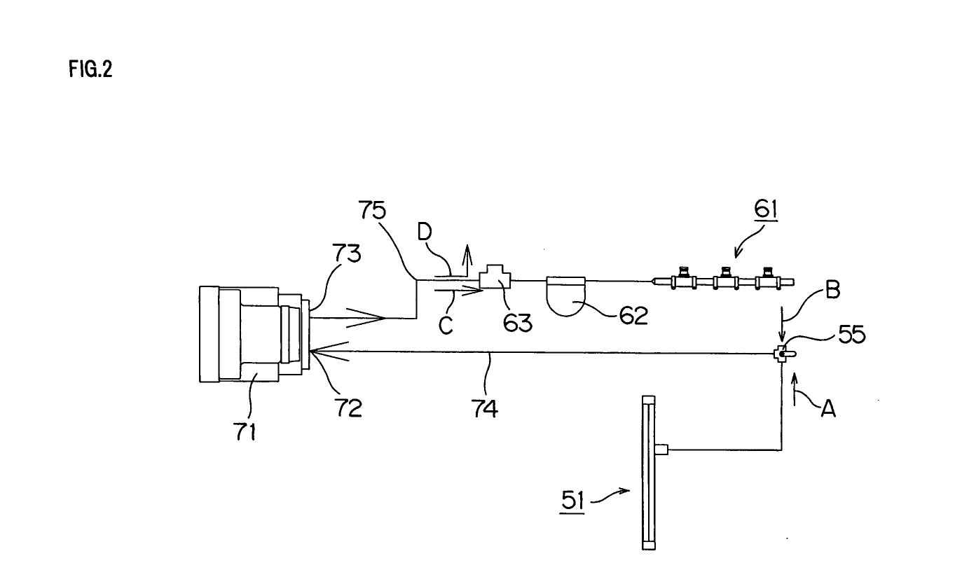

Next, the construction of the decurler 51 and powder mechanism 61, which is the characterizing feature of this invention, will be described. FIG. 2 is a schematic view showing the construction of the decurler 51, powder mechanism 61 and associated components.

This printing machine includes the decurler 51 for correcting curling of printing paper S by sucking the printing paper S after printing, the powder mechanism 61 for applying an anti-offset powder to the printing paper S after printing, a blower 71, a first pipeline 74 connecting the decurler 51 and an intake port 72 of the blower 71, a second pipeline 75 connecting the powder mechanism 61 and an exhaust port 73 of the blower 71, and a powder tank 62 storing the anti-offset powder.

FIG. 3 is an explanatory view showing curl correcting operation of the decurler 51.

As seen, the decurler 51 includes a chamber 52 with a pair of guide members 53 attached to upper parts thereof, and an exhaust port 54 formed in a lower position. The printing paper S having the forward end thereof held and transported by the grippers 30 connected to the chains 23 is drawn in and curved toward the chamber 52 when passing over the guide members 53. This corrects the curling of the printing paper S produced at the printing time.

Referring to FIG. 2 again, the first pipeline 74 has a three-way valve 55 mounted thereon for adjusting a ratio between an amount of air sucked to flow from the decurler 51 to the intake port 72 of blower 71 as indicated by arrow A in FIG. 2 and an amount of air sucked to flow from the atmosphere to the intake port 72 of blower 71 as indicated by arrow B in FIG. 2. This three-way valve 55 can adjust the sucking force of the decurler 51 acting on the printing paper S. Since the amount of air drawn to the blower 71 can be maintained constant by the action of three-way valve 55, the sucking force of the decurler 51 can be adjusted without affecting the powder applying operation of the powder mechanism 61.

The second pipeline 75 has a three-way valve 63 mounted thereon for adjusting a ratio between an amount of air exhausted to flow from the exhaust port 73 of blower 71 to the powder mechanism 61 as indicated by arrow C in FIG. 2 and an amount of air exhausted to flow from the exhaust port 73 of blower 71 to the atmosphere as indicated by arrow D in FIG. 2. This three-way valve 63 can adjust the amount of the anti-offset powder applied by the powder mechanism 61. The amount of air exhausted from the blower 71 can be maintained constant by the action of three-way valve 63. Thus, the amount of the anti-offset powder applied by the powder mechanism 61 can be adjusted without affecting the curl correcting operation of the decurler 51.

In this embodiment, the single blower 71 is shared by the decurler 51 and powder mechanism 61. With such a construction, the amount of air sucked by the blower 71 decreases during a curl correcting operation of the decurler 51, making it impossible to apply the anti-offset powder effectively. However, the printing machine according to this invention prints images in multiple colors by using the first and second plate cylinders 11 and 12 each having a plurality of image areas formed peripherally thereof, and is therefore free from such a problem. This point will be described hereinafter.

FIGS. 4A and 4B are explanatory views of the curl correcting operation of the decurler 51, and the powder applying operation of the powder mechanism 61. FIG. 4A shows a case of using an ordinary printing machine. FIG. 4B shows a case of using a printing machine for multicolor printing using a plate cylinder having a plurality of image areas formed peripherally thereof.

In the ordinary printing machine, a sheet of printing paper S is discharged with each rotation of an impression cylinder. Therefore, as shown in FIG. 4A, printing paper S having a forward end thereof held and transported by the grippers 30 connected to the chains 23 passes the decurler 51 and powder mechanism 61 continually. The printing paper S undergoes the curl correcting operation of the decurler 51 and the powder applying operation of the powder mechanism 61 successively or simultaneously. As noted above, where the single blower 71 is used, the amount of air sucked by the blower 71 decreases due to the curl correcting operation of the decurler 51, and the anti-offset powder cannot be applied effectively.

On the other hand, in the printing machine which prints images in multiple colors by using the plate cylinders each having a plurality of image areas formed peripherally thereof, as in this invention, printing paper S having a forward end thereof held and transported by the grippers 30 passes the decurler 51 and powder mechanism 61 intermittently as shown in FIG. 4B. Thus, a sucking position where printing paper S is sucked by the decurler 51 and a powder applying position of the powder mechanism 61 may be arranged in proper positions spaced apart more than a maximum length in the transport direction of the printing paper S. This enables the powder mechanism 61 to apply the powder when the printing paper S is free from the suction by the decurler 51.

Specifically, in this printing machine, the blower 71 is turned on before starting feeding of printing paper S. In this state, ambient air is always sucked from the decurler 51, and the curl correcting operation is performed when the printing paper S passes the decurler 51. At this time, the three-way valve 63 shown in FIG. 2 exhausts air to the atmosphere as indicated by arrow D. When the printing paper S arrives at the powder applying position, which is confirmed by monitoring the signal from an encoder not shown, the three-way valve 63 is switched to discharge air in the direction indicated by arrow C in FIG. 2. As a result, the anti-offset powder stored in the powder tank 62 is applied to the printing paper S from the powder mechanism 61.

In the printing machine described above, two printing plates are mounted peripherally of each of the first and second plate cylinders 11 and 12, and each impression cylinder 15 or 16 used has half the diameter of the first and second plate cylinders 11 and 12 and the first and second blanket cylinders 13 and 14. This invention is not limited to such a construction.

Where n and m are natural numbers, and the number of image areas formed on the first and the second plate cylinders is [2n], for example, the impression cylinder has a diameter [(2m−1)/2n] times that of the first and second plate cylinders and the first and second blanket cylinders. As a result, the impression cylinder makes [2n] rotations while the first and second plate cylinders and the first and second blanket cylinders make [2m−1] rotations. Since [2n] and [2m−1] are an even number and an odd number, respectively, the sheets of printing paper S, which are [2m−1] in number, mounted peripherally of the impression cylinder will have transferred thereto once each, the [2n] images formed on the first and second plate cylinders while the impression cylinder makes [2n] rotations. Thus, a print will be formed in [4n] colors on one side of printing paper S.

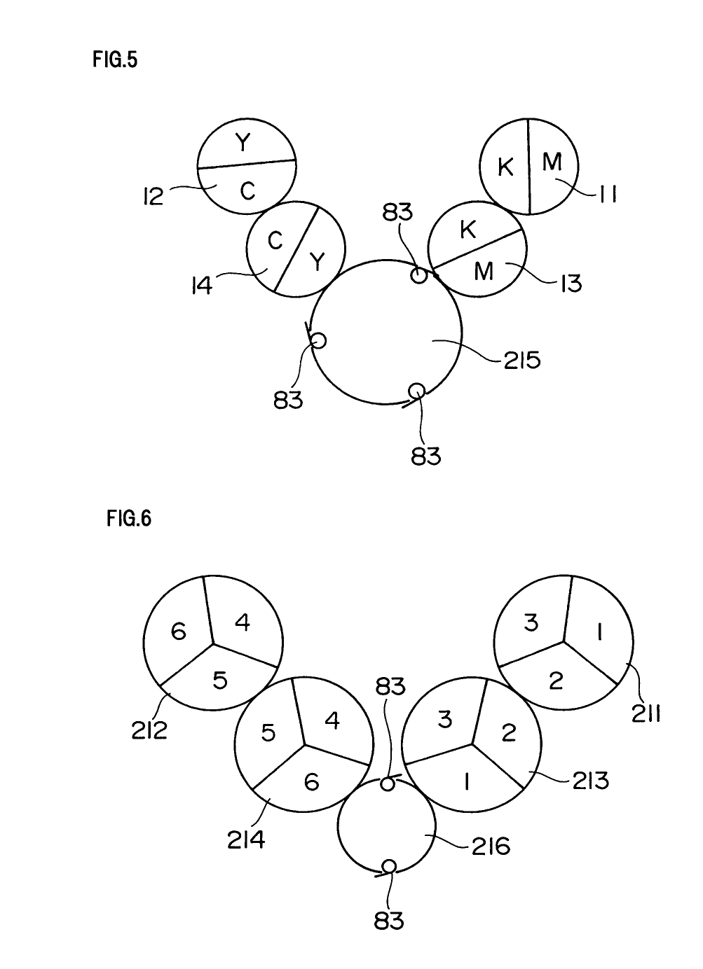

FIG. 5 is an explanatory view illustrating the construction of a printing machine according to this embodiment. Of the entire printing machine, FIG. 5 shows an impression cylinder 215, along with the first and second plate cylinders 11 and 12 and the first and second blanket cylinders 13 and 14 which are similar to those of the printing machine shown in FIG. 1. The other aspects of the construction are the same as those of the printing machine shown in FIG. 1.

In this printing machine, the above natural number n is set to 1, and natural number m to 2. That is, the diameter of impression cylinder 215 is 3/2 times the diameter of the first and second plate cylinders 11 and 12 and the first and second blanket cylinders 13 and 14. Thus, in this printing machine, while the impression cylinder 215 makes two rotations, the first and second plate cylinders 11 and 12 and the first and second blanket cylinders 13 and 14 make three rotations. The impression cylinder 215 has three grippers 83 arranged at equal intervals circumferentially thereof for holding three sheets of printing paper S.

When four-color printing is carried out with this printing machine, the impression cylinder 215 holding three sheets of printing paper S makes two rotations to print the three sheets of printing paper S in the four colors of yellow, magenta, cyan and black. Thus, images can be printed in the four colors continuously by feeding three new sheets of printing paper S from the paper feed cylinder 17 each time the impression cylinder 215 makes two rotations.

Similarly, the impression cylinder may have a diameter 5/2 or 7/4 times that the first and second plate cylinders 11 and 12 and the first and second blanket cylinders 13 and 14. In the former case, the first and second plate cylinders 11 and 12 and the first and second blanket cylinders 13 and 14 make five rotations while the impression cylinder makes two rotations, to print images in four colors on five sheets of printing paper S mounted peripherally of the impression cylinder. In the latter case, the first and second plate cylinders 11 and 12 and the first and second blanket cylinders 13 and 14 make seven rotations while the impression cylinder makes four rotations, to print images in eight colors on seven sheets of printing paper S mounted peripherally of the impression cylinder.

Where n and m are natural numbers, and the number of image areas formed on the first and the second plate cylinders is [2n+1], the impression cylinder has a diameter [2m/(2n+1)] times that of the first and second plate cylinders and the first and second blanket cylinders. As a result, the impression cylinder makes [2n+1] rotations while the first and second plate cylinders and the first and second blanket cylinders make [2 m] rotations. Since [2n+1] and [2 m] are an odd number and an even number, respectively, the sheets of printing paper S, which are [2 m] in number, mounted peripherally of the impression cylinder will have transferred thereto once each, the [2n+1] images formed on the first and second plate cylinders while the impression cylinder makes [2n+1] rotations. Thus, images will be printed in [2(2n+1)] colors on the printing paper S.

FIG. 6 is an explanatory view illustrating the construction of a printing machine according to this embodiment. Of the entire printing machine, FIG. 6 shows an impression cylinder 216, first and second plate cylinders 211 and 212 and first and second blanket cylinders 213 and 214. Although not shown, each of the first and second plate cylinders 211 and 212 has, arranged outside, three ink feeders similar to the ink feeders 20 shown in FIG. 1. The other aspects of the construction are the same as those of the printing machine shown in FIG. 1.

In this printing machine, the above natural numbers n and m are both set to 1. That is, the diameter of impression cylinder 216 is ⅔ times the diameter of the first and second plate cylinders 211 and 212 and the first and second blanket cylinders 213 and 214. Thus, in this printing machine, while the impression cylinder 216 makes three rotations, the first and second plate cylinders 211 and 212 and the first and second blanket cylinders 213 and 214 make two rotations. The impression cylinder 216 has two grippers 83 arranged at equal intervals circumferentially thereof for holding two sheets of printing paper S.

When six-color printing is carried out with this printing machine, the impression cylinder 216 holding two sheets of printing paper S makes three rotations to print the two sheets of printing paper S in the six colors using a first to a sixth colors. Thus, images can be printed in the six colors continuously by feeding two new sheets of printing paper S from the paper feed cylinder 17 each time the impression cylinder 216 makes three rotations. In addition to the usual, four color inks, it is possible to use other color inks called special colors, transparent varnish or the like.

Similarly, the impression cylinder may have a diameter 4/3 or 6/5 times that the first and second plate cylinders 211 and 212 and the first and second blanket cylinders 213 and 214. In the former case, the first and second plate cylinders 211 and 212 and the first and second blanket cylinders 213 and 214 make four rotations while the impression cylinder makes three rotations, to print images in six colors on four sheets of printing paper S mounted peripherally of the impression cylinder. In the latter case, the first and second plate cylinders 211 and 212 and the first and second blanket cylinders 213 and 214 make six rotations while the impression cylinder makes five rotations, to print images in ten colors on six sheets of printing paper S mounted peripherally of the impression cylinder.

This invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Application No. 2007-101310 filed in the Japanese Patent Office on Apr. 9, 2007, the entire disclosure of which is incorporated herein by reference.

What is claimed is:

1. A printing machine for printing images in multiple colors on printing paper by using a plate cylinder having a plurality of image areas formed peripherally thereof, the printing machine having a transport path for transporting the printing paper with the images printed thereon in a transport direction, said printing machine comprising:
a decurler disposed on said transport path for correcting curling of the printing paper by sucking the printing paper with the images printed thereon;
a powder mechanism disposed on said transport path and spaced from said decurler by a distance at least corresponding to a length of the printing paper in the trans-port direction, for applying an anti-offset powder to the printing paper with the images printed thereon;
a blower having an intake port for drawing in air, and an exhaust port for exhausting the air drawn in through said intake port;
a first pipeline connecting said decurler and said intake port of said blower; and
a second pipeline connecting said powder mechanism and said exhaust port of said blower.

2. A printing machine as defined in claim 1, wherein said first pipeline has a three-way valve mounted thereon for adjusting a ratio between an amount of air drawn from said decurler into said intake port and an amount of air drawn from atmosphere into said intake port.

3. A printing machine as defined in claim 1 or 2, wherein said second pipeline has a three-way valve mounted thereon for adjusting a ratio between an amount of air exhausted from said exhaust port to said powder mechanism and an amount of air exhausted from said exhaust port to atmosphere.

4. A printing machine as defined in claim 1, wherein, when n and m are natural numbers that make [2n] and [2m−1] relatively prime, said plate cylinder holds, mounted peripherally thereof, a printing plate having [2n] image areas;
said apparatus comprising:
[2n] ink feeders for contacting and feeding inks to the image areas of the printing plate on said plate cylinder;
a blanket cylinder equal in diameter with said plate cylinder and contactable with said plate cylinder; and
an impression cylinder having a diameter [(2m−1)/2n] times the diameter of said plate cylinder and said blanket cylinder, and said impression cylinder being contactable with said blanket cylinder while holding [2m−1] sheets of the printing paper mounted peripherally thereof.

5. A printing machine as defined in claim 1, wherein, when n and m are natural numbers that make [2n+1] and [2 m] relatively prime, said plate cylinder holds, mounted peripherally thereof, a printing plate having [2n+1] image areas;
said apparatus comprising:
[2n+1] ink feeders for contacting and feeding inks to the image areas of the printing plate on said plate cylinder;
a blanket cylinder equal in diameter with said plate cylinder and contactable with said plate cylinder; and
an impression cylinder having a diameter [2m/(2n+1)] times the diameter of said plate cylinder and said blanket cylinder, and said impression cylinder being contactable with said blanket cylinder while holding [2 m] sheets of the printing paper mounted peripherally thereof.
